(19) United States
(12) Patent Application Publication
(10) Pub. No.: US 2015/0182080 A1
(43) Pub. Date: Jul. 2, 2015

(54) HYGIENIC HANDLE MADE FROM A STICKER BLANK

(71) Applicant: The Infinite Holding B.V., Oosterbeek (NL)

(72) Inventor: Hendrikus Willem Beumer, Winterswijk (NL)

(73) Assignee: The Infinite Holding B.V., Oosterbeek (NL)

(21) Appl. No.: 14/406,786

(22) PCT Filed: Jun. 14, 2013
(86) PCT No.: PCT/NL2013/050422

§ 371 Date: Dec. 10, 2014

(30) Foreign Application Priority Data
Jun. 15, 2012 (NL) 2009012

(51) Int. Cl. A47K 13/10; B32B 37/30

(52) U.S. Cl. CPC A47K 13/105; B32B 37/30

(57) ABSTRACT

A sticker blank for forming a toilet handle has a top layer with a bottom side provided with an adhesive layer. The adhesive layer is provided with a removable cover layer for initially covering the adhesive layer. The sticker blank has at least one bonding portion for attaching the handle to a toilet seat assembly, and at least one handle portion for providing a hand grip. By forming the handle from the sticker blank, the handle can be obtained in a cost-advantageous manner. In addition, the plate-shaped and flexible handle with a thickness of 1 mm at most does not present an obstacle during use.

### CROSS-REFERENCE TO RELATED APPLICATIONS

This application is the National Stage of International Application No. PCT/NL2013/050422 filed Jun. 14, 2013, which claims the benefit of Netherlands Application No. 2009012, filed Jun. 15, 2012, the contents of which is incorporated by reference herein.

### FIELD OF THE INVENTION

The present invention relates to a handle, in particular a hygienic handle such as a toilet handle, which can be fastened to a moveable object, such as a toilet seat.

### BACKGROUND OF THE INVENTION

A toilet handle is known from DE296.06.542. The toilet handle can be mounted on a toilet seat of a toilet seat assembly. The toilet seat is provided with a toilet seat bumper for supporting the toilet seat on a toilet bowl. To mount the toilet handle, the toilet seat bumper is first removed to position the toilet handle in place of the toilet seat bumper that has been removed. The toilet handle is made up of a bonding portion and a handle portion. The bonding portion is provided with an adhesive layer on both sides. After the toilet handle has been put in position, the toilet seat bumper is reinstalled so that the toilet handle is clamped between the toilet seat and the toilet seat bumper. The adhesive layer of the toilet handle sticks to the toilet seat bumper and the toilet seat. The handle portion of the toilet handle extends outwards beyond a circumferential edge of the toilet seat. By grasping the handle portion firmly, a user can move the toilet seat up or down.

One drawback of the known toilet handle is that the toilet handle is inconvenient to use. Specifically, removing the toilet seat bumper to put the toilet handle in place is tedious and unsatisfactory. At the same time, firm fastening of the toilet handle must be achieved. When the toilet seat is moved, the forces applied are great enough to produce a risk of the toilet handle becoming undesirably loose.

Despite the simple design, a drawback of the known toilet handle is that the toilet handle is nevertheless relatively expensive to manufacture. The public perceives the toilet handle as a disposable article, and therefore the purchase price should be minimal.

Another known toilet handle is disclosed in WO91/11949. The toilet handle can be used with only one finger while lifting or lowering a seat or lid of a commode. The toilet handle can be attached by means of self-adhesives.

A drawback to this known toilet handle is that the attachment of the handle is not strong enough. The handle appears to be easily ripped from a seat or lid during use.

A toilet grip is disclosed in ES2.315.075 for operating a toilet seat. The toilet grip can be placed around a portion of an outer circumference of a toilet seat to cover an attachment zone. The attachment zone is covered to provide a clean surface for lifting the seat. This toilet grip has a panel shaped base which is sized in correspondence with a width of a human hand. At an extremity of the base, the toilet grip includes a tip with a ply which forms an upstanding thumb portion.

A drawback of this toilet grip is that a user contacts a toilet bowl underneath the seat when grasping the toilet grip which is highly unhygienic.

### SUMMARY OF THE INVENTION

The present invention aims to eliminate at least one of the above-mentioned drawbacks at least partially, or to provide a usable alternative. In particular, the invention aims to provide an inexpensive toilet handle. More specifically, the invention aims to provide a toilet handle that can be easily and firmly fastened to a toilet seat assembly or toilet lid.

This goal is accomplished with a sticker blank for forming a handle as provided by the present invention.

According to the invention a sticker blank is provided for forming a handle, in particular a toilet handle. The sticker blank has a top layer with a bottom side provided with an adhesive layer. By means of the adhesive layer, the sticker blank can be attached to an object. The adhesive layer, in particular a glue layer, has a removable cover layer for initially covering the adhesive layer. In order to be used the cover layer may be removed by hand in order to subsequently attach the handle. The sticker blank has at least one bonding portion for attaching the handle to a moveable object, in particular a toilet seat assembly. Furthermore the sticker blank has a handle portion for providing a hand grip.

Advantageously a handle is provided that can be formed from a sticker blank. As a result, the handle can be made at a low cost. The sticker blank can be stamped out of a sticker sheet, so that the sticker blank can be obtained in a cost-advantageous manner. The sticker blank can be folded into a handle for use.

Advantageously the handle can be simply applied to an object through adhesion of the adhesive layer. Disassembly of an article, for example removal of a toilet seat bumper, is not necessary.

Advantageously the handle portion of the handle is flexible, so that it forms little or no obstacle in use. When the handle is used as a toilet handle, wherein the handle is fastened to a toilet seat, a user will not find their clothing easily hooked behind the flexible handle. The bonding portion of the handle may advantageously be made flat and thin. The bonding portion may have a thickness of a maximum of 1 mm, particularly at most 0.25 mm, but preferably at most 0.15 mm, so that the bonding portion does not need to form an obstacle when it is fastened to an object. The thin, flat bonding portion, for example, may be fastened to a seating surface of a toilet seat without the presence of the bonding portion being inconvenient for a user of the toilet. The thin, flat bonding portion also need not form an obstacle during cleaning activities. The object and the handle can be easily cleaned by removing the handle with a cloth.

In an embodiment of the sticker blank according to the invention, the handle is made in one part. The handle is formed from a one-piece sticker blank. In particular the handle is formed by folding. The handle preferably includes a plastic film. The top layer of the sticker blank is advantageously made of plastic. The top layer of the sticker blank preferably does not contain any paper. Advantageously, the plastic film provides strength to the handle and the handle is liquid-resistant. In addition the plastic film may be impermeable to microbes, so that the handle is hygienic in use, in contrast to a handle containing paper.

In an embodiment of the sticker blank according to the invention, the sticker blank contains a layered material. The sticker blank may be made of at least 3 layers. The top layer may be laminated and comprise multiple layers, for example 2 layers. A top layer may contain an antibacterial film that forms an upper protective layer. The top layer may contain a supportive layer for supporting the film. The film may be applied to the supporting layer, made for example of paper or plastic, by means of a first adhesive layer, a glue or gum layer. On a bottom side, the supporting layer is provided with a second adhesive layer, a glue or gum layer. In addition the sticker blank has a cover layer, a backing paper, which is provided at least on a top side with a silicone or PE layer. The cover layer may be provided on a bottom side with a lip projecting beyond the top layer to make it easier to pull off the cover layer for use.

In an embodiment of the sticker blank according to the invention, the sticker blank is elongated, and the sticker blank contains two bonding portions positioned on the two ends of the sticker blank. The sticker blank contains at least one handle portion that is positioned in a centrally located area. The handle portion is positioned between the two bonding portions. Through the presence of 2 bonding portions and 1 centrally located handle portion, the two bonding portions on opposite sides of the handle portion can be more effectively bonded to a surface. In this way the handle can be advantageously fastened more firmly to the surface, in that a peeling-off force on the bonding portions when pulling on the handle is eliminated. Advantageously, the double adhesive provides for stronger connection of the handle to the object, reducing the risk that the handle will undeniably slip or come loose from the object. Due to the presence of two bonding portions, the handle may be fastened on two opposite sides of an object. For example, the handle, as a toilet handle, may be fastened to both a top side and a bottom side of a toilet seat or a toilet lid. As a result the toilet handle, with a pair of bonding portions, is advantageously more firmly fastened compared with fastening with a single bonding portion.

In an embodiment of the sticker blank according to the invention the top layer of the sticker blank has a thickness of at least 0.15 mm, in particular at least 0.2 mm, more particularly at least 0.3 mm, so that the handle to be formed will be suitable for use as a toilet handle and/or cabinet door handle. As a result the toilet handle is strong enough for operating a toilet seat and/or a toilet lid.

In an embodiment of the sticker blank according to the invention, the sticker blank contains at least one fold line for folding the sticker blank in a folding direction. By folding the sticker blank, part of the sticker blank can be doubled, resulting in a reinforced part. The reinforced part of the sticker blank is suitable for functioning as a handle portion.

In an embodiment of the sticker blank according to the invention, the fold line is positioned in a centrally located area of the sticker blank. The sticker blank can be doubled over the fold line. By doubling over the sticker blank, two bonding portions located opposite one another will come to lie against one another. Preferably a cover layer, in particular a double-sided cover layer, a double-sided backing paper, is provided between the two bonding portions opposite one another. In a particular embodiment, the first bonding portion in the double-folded state, which is an intermediate state for delivery, may be immediately adjacent to the second bonding portion without an intervening cover layer. Then the adhesive layers of the bonding portions are positioned directly against one another. The bonding portions may be pulled apart from each other by a user to place the handle made of the sticker blank on an object. In this embodiment therefore the one bonding portion serves as a cover layer for the other bonding portion. Preferably one of the bonding portions in this case is provided with a pull-off lip, so that the two bonding portions can be easily pulled apart from one another.

In an embodiment of the sticker blank according to the invention, the sticker blank has two handle portions that are positioned in a centrally located area of the sticker blank. The two handle portions are connected to one another by a fold line. In particular the sticker blank has a centrally located fold line for doubling over the handle portions of the sticker blank. The fold line may be a marked line and/or a pre-folded score line, crease or stamped line. The two handle portions can be folded together over the fold line to form a stiff handle together.

In an embodiment of the sticker blank according to the invention, the at least one handle portion of the sticker blank is stiffened with a stiffening layer. The handle portion may be laminated with a stiffening layer. The stiffening layer may be a cover plate over a cut-out in the handle portion. During the forming of the handle from the sticker blank, the handle portions may be stiffened by applying a stiffening layer between two handle portions. The stiffening layer for example is made of plastic, paper, cardboard, etc. The handle made from the sticker blank may be supplied to a user in an intermediate state, in which the handle portions are already bonded together, but wherein the bonding portions of the handle are also provided with a cover layer. The handle portions in the intermediate state may be provided with the stiffening layer. In an alternative embodiment the stiffening layer may be sleeve-shaped, wherein the sleeve-shaped stiffening layer in the intermediate state of the handle is applied over the handle portion. Furthermore the stiffening layer may be useful for applying advertising messages.

In an embodiment of the sticker blank according to the invention, the sticker blank is elongated. The sticker blank has a relatively greater length than width. In particular the sticker blank has a length that is at least 5 times greater than the width of the sticker blank. The sticker blank has a longitudinal axis that extends in the lengthwise direction. The sticker blank has at least one fold line that extends in a transverse direction relative to the longitudinal axis. In particular, the sticker blank is made to be bilaterally symmetrical around the longitudinal axis. More particularly, the sticker blank is made to be bilaterally symmetrical around a centrally located transverse axis.

In an embodiment of the sticker blank according to the invention, the sticker blank has a transitional fold line which is positioned between a bonding portion and a handle portion. The transitional fold line forms a borderline of the bonding portion of the handle portion. The sticker blank is folded over the transitional fold line in a direction opposite the fold line. After the folding of the sticker blank over the fold line, the sticker blank may be folded over the transitional fold line to bring the handle into an intermediate position.

In an embodiment of the sticker blank according to the invention, the sticker blank also has a tapered portion in the area of the transition between the bonding portion and the handle portion. When a hand grip is formed by folding together handle portions and sticking them together, the transitional fold line and the taper advantageously form a clear transition from the hand grip to the bonding portion so that pulling forces occurring during use reduce the risk of pulling off the handle portions.

In an embodiment of the sticker blank according to the invention, the transitional fold line has at least one slit. The slit extends partially over the transitional fold line. Preferably the slit is positioned in a central area of the transitional fold line, such that the bonding portion is connected to the handle portion only on the outer circumference. Preferably a bonding portion of the sticker blank is connected to a handle portion at the outer circumference over a maximum length of 3 mm over the transitional fold line. The slit may be formed as a perforation line. The slit may be applied by means of a stamping process. Specifically, when a handle is formed from a relatively thick sticker blank, the slit reduces the force required for the doubling over of the sticker blank. An additional advantage is that the slit may be configured such that the handle portion tears off from the bonding portion after reaching a predetermined useful life. In this way it is possible to prevent the handle from being used too long in view of the hygienic requirements, and the risk of contamination can be reduced. A relatively large slit over a large fraction of the transitional fold line would result in a shorter useful life, while a relatively small slit over a small part of the transitional fold line would extend the useful life.

In the embodiment of the sticker blank according to the invention, the handle portion has a maximum size of 10 cm², such that the handle portion forms a grasping portion for grasping with a thumb and a forefinger. Advantageously the handle portion is large enough to grasp between the thumb and the forefinger, while the handle portion is small enough not to form an obstacle on, for example, the toilet seat. Preferably the handle portion has a width of at least 15 mm, in particular at least 20 mm, at the level of the transition from the handle portion to the bonding portion. Advantageously the broad transition provides sufficient strength for managing relatively heavy objects, such as the handling of a toilet seat assembly or cabinet door.

In an embodiment of the sticker blank according to the invention, the bonding portion has a cut-out. The bonding portion has a cut-out such that the bonding portion adheres more firmly to an irregular substrate. An irregularity of the substrate can be accommodated in the cut-out of the bonding portion.

In an embodiment of the sticker blank according to the invention, the handle portion has a cut-out. The cut-out of the handle portion makes it possible to incorporate an additional item in the handle portion. An additional item is, for example, a sensor, indicator, or a source of light, scent or sound.

In an embodiment of the sticker blank according to the invention, the sticker blank is rotationally symmetrical. An outline of the sticker blank is rotationally symmetrical.

In an embodiment of the sticker blank according to the invention, the sticker blank contains an antibacterial material. The top layer of the sticker blank may contain an antibacterial material. The antibacterial material may be integrated in the top layer of the sticker blank. An antibacterial effect can be achieved by using different raw materials. Microban technology may be integrated in the top layer. Microban is a technology that can be incorporated in an antibacterial material. Preferably the top layer of the sticker blank meets the standard for antibacterial material according to ISO 22196:2007. In particular, the sticker blank contains biocidal substances. In particular the antibacterial material is suitable for combatting microbes, in particular for combatting MRSA bacteria, E. coli or Staphylococcus aureus and the like.

In an embodiment of the sticker blank according to the invention the sticker blank contains a top layer with a film. The sticker blank may contain a top layer with an antibacterial coating or film, particularly a SIGMAGraF™ Shield AM, Foil-Coat AM, Hexis antibacterial film, Autotex AM with Microban, or Mac Dermid autotype, etc. The film preferably contains an antibacterial material. The top layer of the sticker blank, in particular the film, is preferably resistant to solvents and chemicals usually employed in cleaning a sanitary environment, such that the sticker blank can be cleaned in a usual manner. Preferably the top layer of the sticker blank, in particular the film, is mechanically resistant, such that the film may be cleaned with the aid of scrubbers such as are usually employed in a sanitary environment. Mac Dermid autotype SIGMAGraF™ Shield AM is a self-sticking, durable film with a specific layer composition including Microban. The growth of a broad selection of microbes can be guaranteed and permanently inhibited to the extent of almost 100%. The antibacterial material makes the sticker blank suitable for formation of a hygienic handle to promote hygiene during use.

In an embodiment of the sticker blank according to the invention, the sticker blank contains a top layer of a photoluminescent material. Advantageously, a handle made from the sticker blank may light up during use in a dark environment. The handle made from the sticker blank is thus advantageously suitable for application to a light switch.

In an embodiment of the sticker blank according to the invention, the top layer of the toilet handle may have an information carrier on the top side. The information carrier has, for example, an advertising message. The top layer may be provided with an image. The top layer may have a film layer with the information carrier. The top layer may for example be provided with an advertising message such as a trade name or logo. The toilet handle may contain an image directed towards children. The toilet handle may be designed as part of a special line of products for children with images of for example Bob the Builder, SpongeBob, Bobo, Dora, Buurman & Buurman, K3, etc. Advantageously children can be encouraged in this way to use the toilet handle. Consequently the toilet handle is particularly suitable for use in facilities for children, such as schools, child-care facilities, indoor play areas, swimming pools, camping grounds, child-friendly restaurants such as a pancake house, McDonald's, etc.

In an embodiment of the sticker blank according to the invention, the top layer of the sticker blank has a bottom side in which a marginal portion of the bottom side is free from an adhesive layer. The portion of the bottom side that is free from an adhesive layer forms a pull-off lip. No glue layer is provided on the bottom side of the pull-off lip. As a result, the pull-off lip will not adhere to an object and a space is provided where a user can grasp the handle to subsequently pull it off. With the aid of this pull-off lip, an applied handle can if necessary be pulled off of the object again. In a particular embodiment, the pull-off lip has a rough surface to give a user a better grip of the pull-off lip. The surface is rough so that a person can also use the pull-off lip while wearing gloves.

In an embodiment of the sticker blank according to the invention, the sticker blank may have a cover layer, wherein the cover layer is provided with a rough surface that allows the user a better grip for pulling off the cover layer to put the handle in place. The rough surface may be designed such that a user can remove the cover layer while wearing gloves.

In an embodiment of the sticker blank according to the invention, the sticker blank contains one double-sided cover layer. The double-sided cover layer has a bottom side and a top side which are formed as a contact layer to lie adjacent to the adhesive layer. The contact layer contains, for example, silicones, so that the cover layer adheres removably against the adhesive layer. In a folded-together state of the handle, the one cover layer is located between the two bonding portions of the handle. The folded-together state of the handle forms a starting position for use. A user can open the folded handle, so that a first bonding portion of the handle is directly available to be applied to a surface of an object. Then the cover layer can be removed, so that the second bonding portion can be applied to the object. The handle with a single cover layer may advantageously be rapidly applied for covering the first and second bonding portions.

In an additional embodiment of the sticker blank according to the invention, the cover layer has a lip portion that projects beyond the outer contours of a bonding portion. The projecting lip part makes it easier to pull the sticker blank open from the folded-together state.

In an embodiment of the sticker blank according to the invention, the cover layer is provided with an information carrier. The cover layer may be provided, for example, with an image or advertising message.

In an embodiment of the sticker blank according to the invention, the sticker blank contains a luxury item, such as a crystal, a precious stone and/or a rhinestone. The luxury item may be attached to the top layer of the sticker blank. The luxury item may be positioned on a handle portion or a bonding portion. The top layer may be provided with a cover layer with a luxurious radiance, such as a cover layer of gold, silver or copper. Thus the sticker blank can have a luxurious radiance.

In addition the invention relates to a handle made from a sticker blank. In an embodiment the handle contains instructions for use with instructions for making the handle from the sticker blank. The instructions include the step of folding the sticker blank over a centrally located fold line. The instructions include the step of removing a cover layer. The instructions include the step of applying a first bonding portion of the sticker blank to an object. In particular, the instructions include a step for applying a second bonding portion of the sticker blank to an object.

Furthermore the invention relates to a packet of sticker blanks for forming handles. The sticker blanks are made in sizes suitable for forming handles for manipulating relatively heavy moveable objects such as a toilet seat assembly or cabinet door. The relatively heavy objects may require an operating force of at least 5 N, in particular at least 10 N.

The sticker blanks may be packaged in a pouch or on a roll. The invention particularly relates to a sticker roll containing sticker blanks according to the invention. In particular, the packet contains sticker blanks with various properties, in particular various dimensions, for forming various handles to give alternative embodiments of handles for various circumstances.

In particular the invention relates to a packet of sticker blanks, wherein the packet also contains a cleaning agent. The cleaning agent is, for example, a degreasing agent, a cleaning cloth, cleaning sponge, etc. In particular the invention relates to a cleaning packet, in particular a toilet cleaning packet.

In addition the invention relates to a method for providing a handle, in particular a hygienic handle, such as a hygienic toilet handle, on an object, in particular a toilet seat assembly. In this method the handle is made from a sticker blank.

The method includes a step comprising the creation of the handle according to the invention, wherein the handle contains a bonding portion and a handle portion. The method includes a step of removing a cover layer from the bonding portion of the handle. The method includes a step of bonding the bonding portion to a moveable object.

In an embodiment of the method according to the invention, the method comprises a sticker blank with a fold line, wherein the method also includes the step of folding the sticker blank over the fold line.

In an embodiment of the method according to the invention, a bonding portion is bonded onto the object close to an exterior circumferential edge of the object. In particular, in such a manner that the handle portion is located outside the circumferential edge of the object.

In an embodiment of the method according to the invention, the handle comprises a first and a second bonding portion. In one step of the method the first bonding portion may be bonded to an upper surface of an object and the second bonding portion to a lower surface of the object, for example a toilet seat or toilet lid. In one step of the method the first and second bonding portions on opposite sides of the handle portion may be bonded to a surface of the object that extends basically perpendicular to a surface formed by the handle portion. After attachment the handle portion is centrally positioned relative to the first and second bonding portions. When a pulling force is exerted on the handle portion, the pulling force will be conducted to the bonding portions. The transmitted pulling force assures a shear force in a contact surface between the bonding portion and the object. In this way a firm connection is advantageously obtained between the handle and the object.

In addition the invention relates to the use of the sticker blank for forming a handle for moving relatively heavy moveable objects, such as toilet seat assemblies. In particular the invention relates to the use of the sticker blank for forming a hygienic handle in a sanitary environment. In particular the invention relates to the use of sticker blanks for forming a hygienic handle in a public sanitary environment, such as a public toilet or a hospital. The hygienic handle may be fastened, for example, to a toilet seat assembly, a sanitary piece of furniture, a sanitary drawer, cabinet door, etc.

Further embodiments and aspects according to the invention are included in the dependent claims and are described on the basis of the attached drawings.

### BRIEF DESCRIPTION OF THE DRAWINGS

The invention will be explained in further detail based on the attached drawings. The drawings form a practical embodiment of the invention, which is not to be regarded in a limiting fashion. The exemplified embodiment in the form of a toilet handle is not to be interpreted as limiting for the invention, which is directed towards a handle in a general application, wherein the handle may be formed from a sticker blank. Specific detailed characteristics may also be considered, separately from the exemplified embodiment, in general as characteristic for the invention, wherein:

FIG. 1A shows a perspective view of a toilet seat assembly with a toilet handle according to the invention;

FIG. 1B shows a detail view of a fastening of a toilet handle to a toilet lid;

FIG. 1C shows a detail view of a fastening of a first toilet handle to a toilet lid and a second toilet handle to the toilet seat;

FIG. 2A shows a perspective view of a sticker blank according to the invention in an open configuration for forming a handle, in particular a toilet handle;

FIG. 2B shows a perspective view of a sticker blank according to the invention in an intermediate state for use;

FIG. 3A shows a sticker blank according to the invention in a top view, wherein the sticker blank is bilaterally symmetrical and has two bonding portions and two handle portions; and

FIG. 3B shows a bottom view of the sticker blank from FIG. 3A;

FIG. 3C shows a top view of a sticker blank, wherein the sticker blank has perforated fold lines;

FIG. 3D shows a top view of a sticker blank, wherein the sticker blank contains at least one cut-out;

FIG. 3E shows a top view of a sticker blank for forming a handle for application on a planar bottom side of a sanitary object;

FIG. 3F shows a top view of the sticker blank from FIG. 3E in an folded-together state;

FIG. 3G shows a perspective view of an item that can be incorporated in a toilet handle as shown in FIG. 3D;

FIG. 3H shows a top view of an alternative embodiment of a sticker blank for forming a handle;

FIG. 3I shows a top view of a variant of the embodiment according to FIG. 3H;

FIG. 3J shows a top view of a sticker blank with an enlarged bonding portion;

FIG. 3K shows three different dimensions of a toilet handle;

FIG. 4 shows a folded sticker blank for forming a handle in an intermediate position; and

FIGS. 5A-5F show successive folding motions for obtaining a handle from a sticker blank.

### DETAILED DESCRIPTION OF THE INVENTION

In the figures, the same reference numbers were used for identical or similar parts.

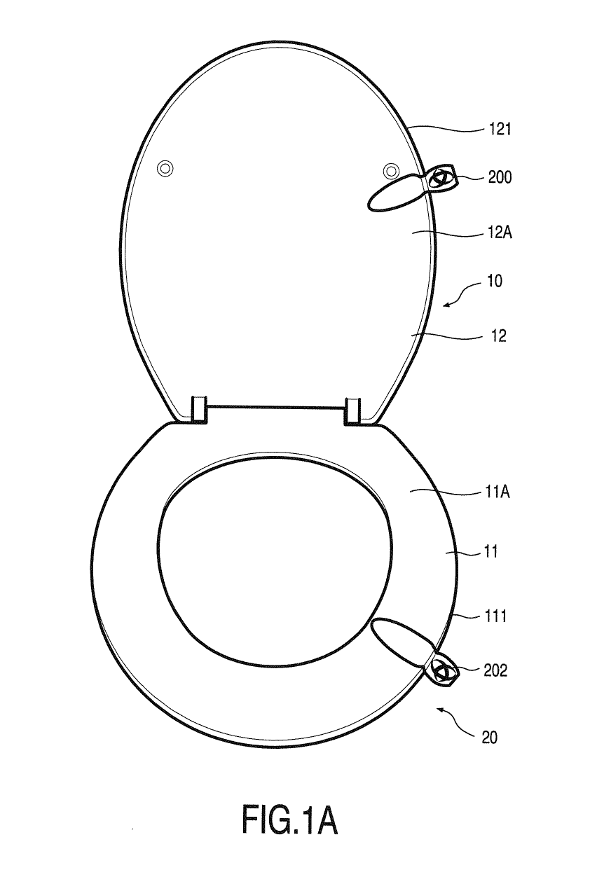

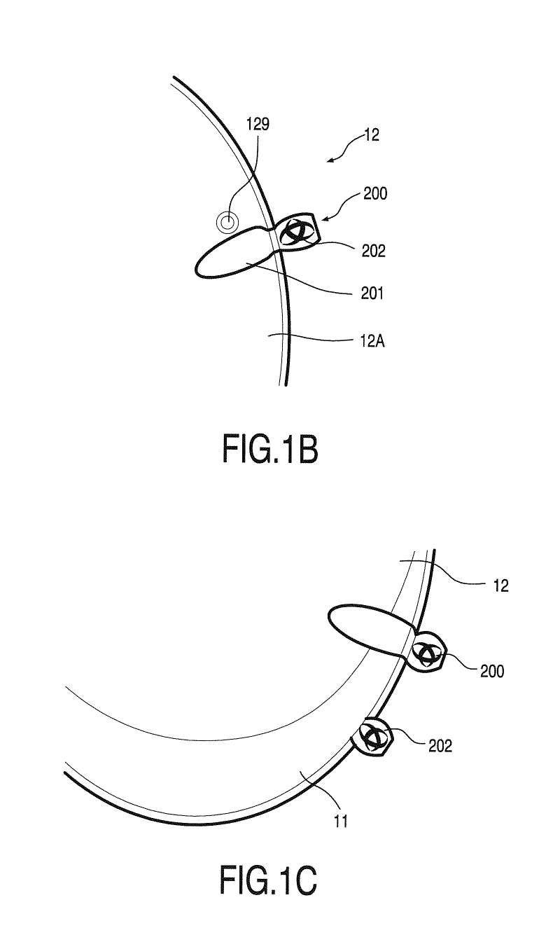

FIG. 1A shows a toilet seat assembly 10 in a perspective view. Such toilet seat assemblies 10 are universally familiar. The toilet seat assembly 10 has a toilet seat 11 and a toilet lid 12. The toilet lid is connected by hinges with the toilet seat. The toilet seat is connected by a hinge at the back with the toilet lid. The toilet seat assembly is shown in an open position. When the toilet lid is moved downward and is supported on the toilet seat, the toilet seat assembly is in a closed position.

The toilet lid is shown in a raised condition with respect to the toilet seat. The toilet lid 12 is flat. The toilet lid has a bottom side 12A and a top side. The toilet lid has a toilet lid circumferential edge 121 located on the outside.

The toilet seat 11 has an upper surface 11A and a lower surface 11B. The upper surface functions as a seating surface for a person sitting on the toilet seat assembly. The toilet seat 11 has a circumferential toilet seat edge 111 located on the outside that at least partially blocks a centrally located, open toilet seat part. As shown, the circumferential toilet seat edge 111 can completely block the centrally located toilet seat part. In an alternative embodiment of the toilet seat, a front area of the circumferential toilet seat edge may be open. In a front area, the toilet seat assembly 10 is freely accessible and the toilet seat offers a seat for a person.

The toilet seat 11 and the toilet lid 12 are each provided with a toilet handle 200. The toilet lid 12 can be operated separately from the toilet seat 11. The toilet handle 200 is positioned on the exterior circumferential edge 111, 121 of the toilet seat 11 or the toilet lid 12. The toilet handle 200 has a fastening portion, in particular a bonding portion 201 that is adhered to a relatively smooth part, a smooth surface, of the toilet seat or the toilet lid. Advantageously the toilet handle 200 has two bonding portions 201, wherein one first bonding portion 201A is fastened to a top side and a second bonding portion 201B is fastened to a bottom side of the toilet lid 12 or toilet seat 11.

The toilet handle 200 has a grasping portion, in particular a handle portion 202 that extends outside of the circumferential edge 111, 121 of the toilet seat or the toilet lid. The handle portion 202 can be grasped by the hand of a person to move the toilet lid, the toilet seat or a combination of the toilet lid and the toilet seat from a lowered position to a lifted position and vice versa. The handle portion has a rounded, roundly extending circumferential edge. The handle portion is essentially circular. The handle portion has a handle portion surface, a grasping surface, in particular a finger grasping surface, with a size of at least 2 cm², in particular at least 3 cm², such that the handle portion can be grasped by a user between a thumb and an index finger. Preferably the handle portion has a maximum size of 10 cm² and a minimum of 5 cm². The handle is in particular suitable as a toilet handle.

The toilet handle 200 is flat. The toilet handle is made from a flat sticker blank. The sticker blank can be folded to form a toilet handle 200. The sticker blank has a maximum thickness of 1 mm, in particular a maximum of 0.25 mm and preferably a maximum of 0.15 mm. The sticker blank has a bonding portion and a handle portion. The bonding portion 201 is positioned following the handle portion 202. The bonding portion 201 is designed to be adhered to a surface of a toilet seat 11 or a toilet lid 12. The upper surface of a toilet seat is always essentially smooth, so that the bonding portion of the sticker blank adheres well to the toilet seat.

The handle portion of the toilet handle is flat. In a simple embodiment in which the toilet handle is not folded, the handle portion has essentially the same thickness as the bonding portion of the toilet handle. In a more complex embodiment of the toilet handle, the sticker blank can be doubled at least once to produce a handle portion that is thicker than the bonding portion.

The sticker blank contains a laminated material. The sticker blank contains a layered material. The sticker blank has a top layer which is provided with an adhesive layer, in particular a glue layer, on a bottom side. The bottom side of the top layer is at least partially covered with the adhesive layer.

Initially, before the toilet handle is put into position, the adhesive layer is covered by the toilet handle with a cover layer 213, also known as backing paper. The cover layer can be manually removed from the sticker blank. Thus the sticker blank for the toilet handle has a top layer, an adhesive layer, in particular a glue layer, and a manually removable cover layer.

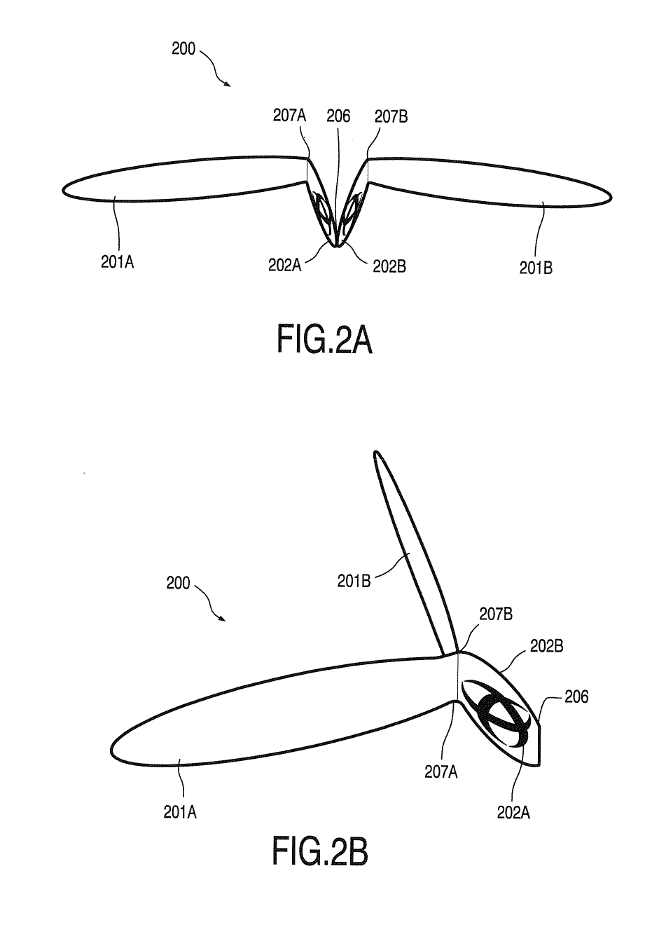

FIG. 1B shows a detailed view of the toilet handle 200, as shown in FIG. 1A, wherein the toilet handle is attached to the toilet lid. The toilet lid has a toilet lid bumper 129 for allowing the toilet lid 12 to be supported on the toilet seat 11. The toilet handle 200 is attached nearby and alongside the toilet lid bumper 129, such that the toilet handle is located in an ergonomic area for a user. The toilet handle 200 is attached to a flat surface 12A of the toilet lid near an outer contour. The bonding portion of the toilet handle 200 is attached close to the circumferential edge 121. The bonding portion 201 of the toilet handle 200 is attached to a bottom side 12A of the toilet lid 12. When the toilet lid 12 is being moved, the weight of the toilet lid 12 can be supported by the fastening of the toilet handle 200 to the bottom side 12A. As a result of the fastening to the bottom side 12A, a shear force is exerted on the glue bond and a firm connection is obtained between the toilet handle 200 and the toilet lid 12. In addition to adhesion to the bottom side 12A of the toilet lid, the toilet handle 200 is also adhered to a top side, a lower surface 12B of the toilet lid 12. The toilet handle 200 has two bonding portions 201 as seen in FIG. 2A, wherein a first bonding portion 201 is fastened to the bottom side 12A of the toilet lid 200, and wherein a second bonding portion 201 is fastened to the top side 12B of the toilet lid. Advantageously the double adhesion of the toilet handle 200 to the toilet lid provides a firm fastening. The same method of fastening is applied for fastening the toilet handle 200 to the lower and upper surfaces 11A, 11B of the toilet seat 11. Advantageously in this way the sanitary handle can be firmly fastened onto an object with an upper and a lower surface.

The toilet lid 12 has a bottom side, a lower surface 12A with a curved circumferential edge. The bonding portion 201 of the toilet handle is flexible, such that it can be attached to a curved surface. The bonding portion 201 follows the curvature of the bottom side 12A. The bonding portion 201 of the toilet handle is made longitudinal. The bonding portion of the toilet handle is elliptical. The bonding portion of the toilet handle contains no sharp angles, so that the risk of at least partial release of the bonding portion 201 is reduced, so that a risk of soiling is decreased.

FIG. 1C shows a perspective view in detail of a toilet seat assembly 10 in a closed position. In the closed position the toilet lid 12 is supported on the toilet seat 11 such that the centrally located opening of the toilet seat 11 is covered. Both the toilet lid 12 and the toilet seat 11 of the toilet seat assembly are provided with a toilet handle 200. The handle portions 202 of the toilet handles 200 extend outside of the outer contours of the toilet seat 11 and the toilet lid 12. A user, by grasping the toilet handle 200, which is fastened to the toilet seat 11, can raise the toilet seat 11 together with the toilet lid 12, but can also raise the toilet lid 12 separately from the toilet seat 11. The fastening of the toilet handle to the lower and upper surfaces is thus sufficiently strong to lift the total weight of the toilet lid with the toilet seat.

FIG. 2A shows a perspective view a toilet handle 200 made from a sticker blank. The toilet handle 200 is shown in an initial position, in which the sticker blank contains a cover layer which covers an adhesive layer. The handle portions 202 are not yet bonded together. A toilet handle 200 in the starting state, also known as the initial state, may be supplied for fastening to a toilet seat assembly 10. The toilet handle 200 is longitudinal. The toilet handle 200 has a longitudinal axis L-L in the lengthwise direction. The toilet handle 200 has a top side and a bottom side. The bottom side is provided with an adhesive layer. The top side is provided with a finishing layer. The finishing layer is, for example, a coating. The finishing layer preferably contains an antibacterial material. The finishing layer may contain an image. The toilet handle 200 has two ends and a centrally located area. The toilet handle 200 has two bonding portions 201. The bonding portions 201 are positioned at both ends of the toilet handle 200. The toilet handle 200 has two handle portions 202. The first bonding portion 201A is connected via a first transitional fold line 207A to the first handle portion 202A. The second bonding portion 201B is connected via a second transitional fold line 207B to the second handle portion 202B. The first handle portion 202A is connected via a centrally located fold line 206 with the second handle portion 202B.

In a perspective view FIG. 2B shows a toilet handle 200 formed from the sticker blank, wherein the toilet handle 200 is shown in an intermediate state. In the intermediate state the first handle portion 202A is bonded to the second handle portion 202B. By folding together the handle portions 202A, 202B over the centrally located fold line 206, a stiffer handle portion 202 is obtained. The bonding portions 201A, 201B are provided with a cover layer in the intermediate state. After the handle portion 202 has been shaped and brought into the intermediate state, the cover layer may be removed and the toilet handle 200 may be applied to a toilet seat assembly 10 as shown in FIGS. 1A-C. The handle portions 202 may be further stiffened with a stiffening layer. The stiffening layer may be applied between the handle portions 202A, 202B before the handle portions are folded together. The stiffening layer may contain a plastic, paper or cardboard.

The dimensions of the toilet handle 200 are such that the toilet handle 200 is suitable for use on a great variety of toilet seat assemblies. The dimensions of the toilet handle 200 are such that the toilet handle 200 is suitable for almost any toilet seat assembly. The toilet handle 200 has a bonding portion with a length in the longitudinal direction L-L of at least 40 mm, in particular at least 50 mm, but preferably at least 55 mm. The bonding portion preferably has a maximum length of 80 mm. In particular, both bonding portions 201A, 201B are of the same length. The toilet handle 200 has a handle portion with a length in the longitudinal direction L-L of at least 15 mm, but preferably at least 20 mm. In particular the toilet handle 200 has a width over its entire length of at least 15 mm, in particular at least 20 mm and a maximum of 40 mm. preferably the toilet handle 200 has a width over the entire length of at least 25 mm and maximally 35 mm.

The embodiment shown in FIG. 2B is particularly distinguished in appearance. The shape of the sticker blank in the intermediate state is similar to that of a helicopter-shaped seed of an ash tree.

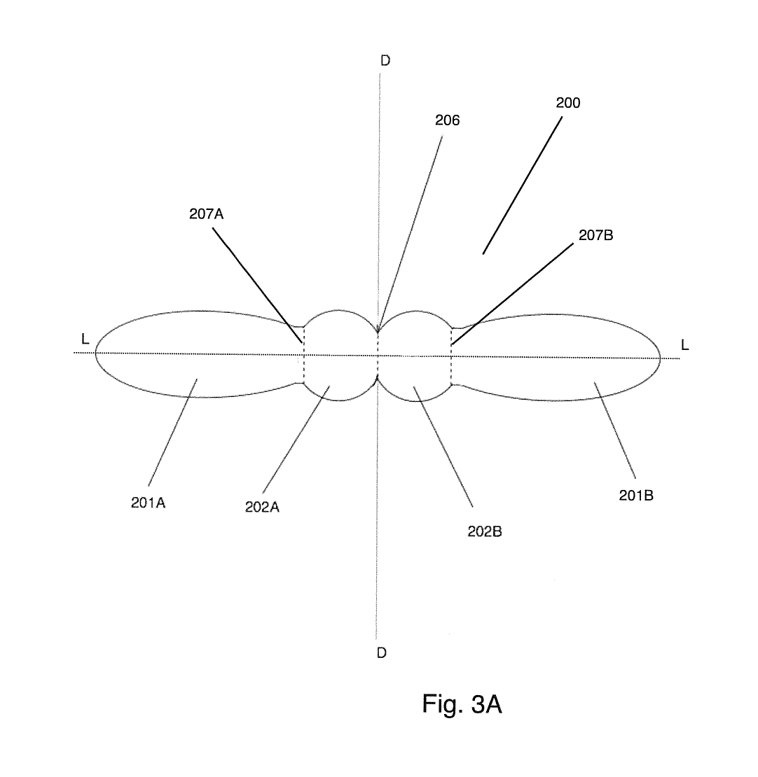

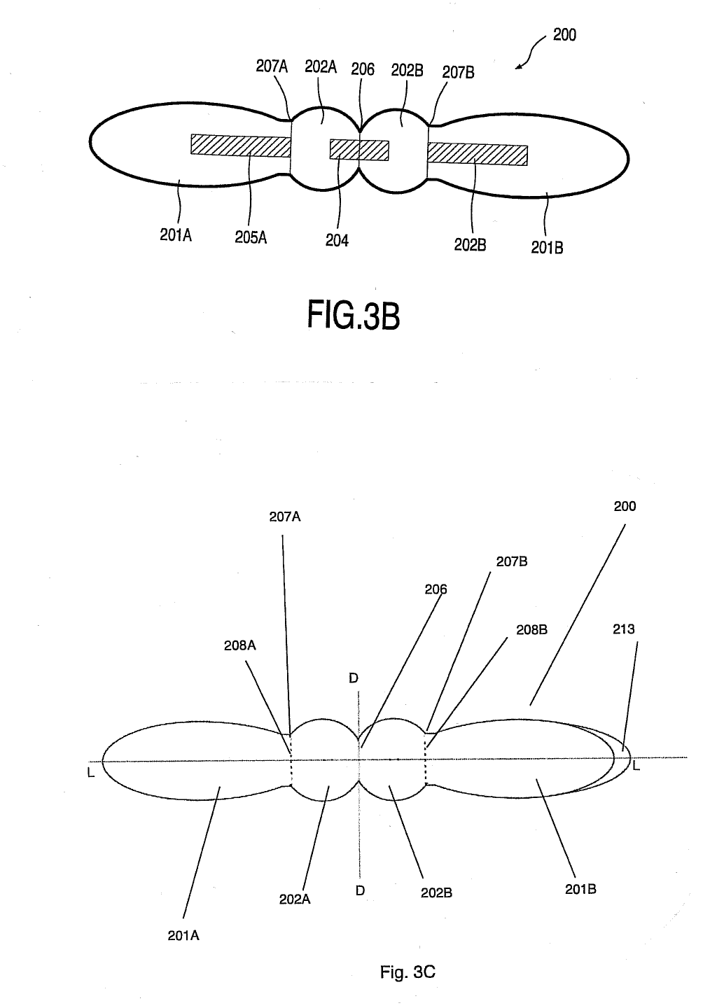

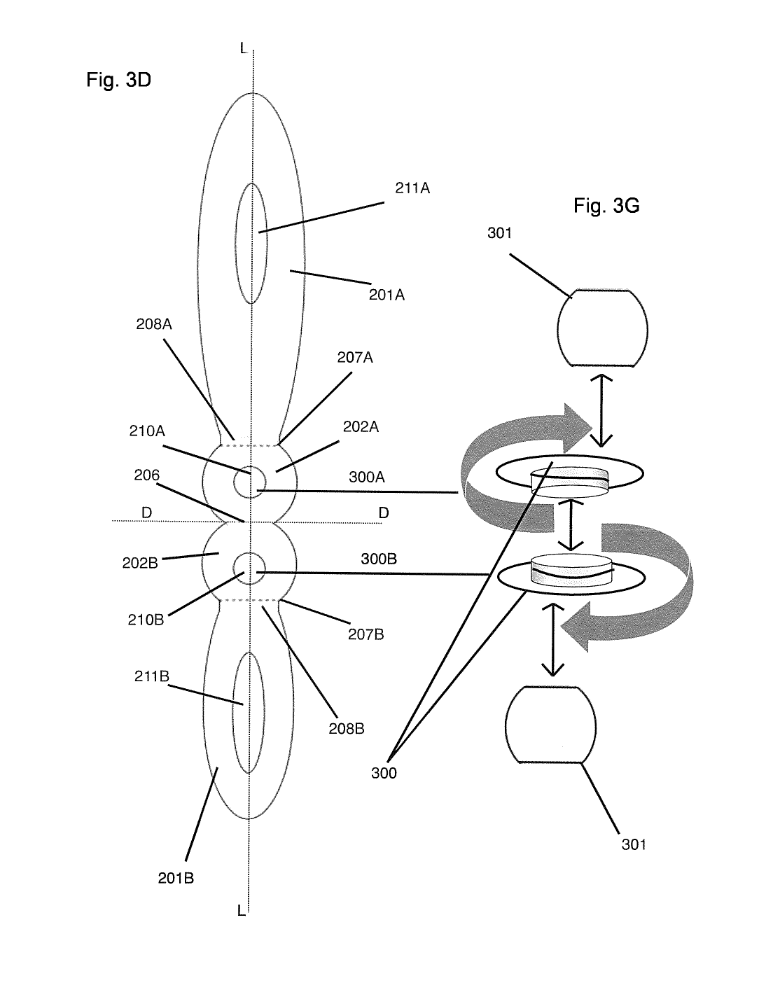

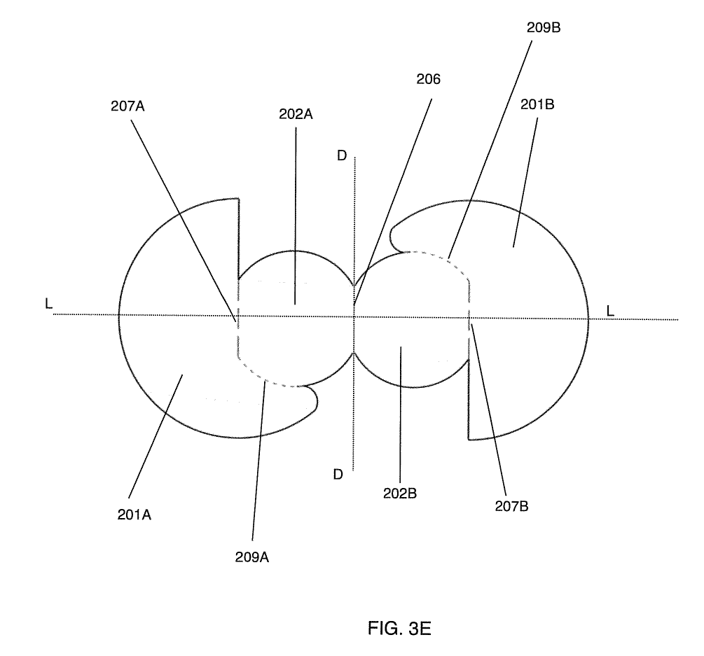

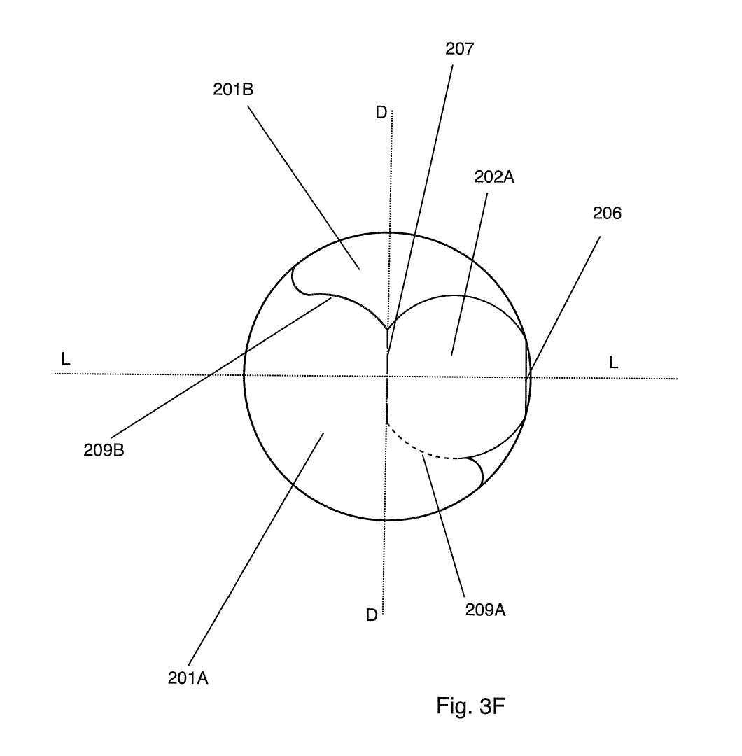

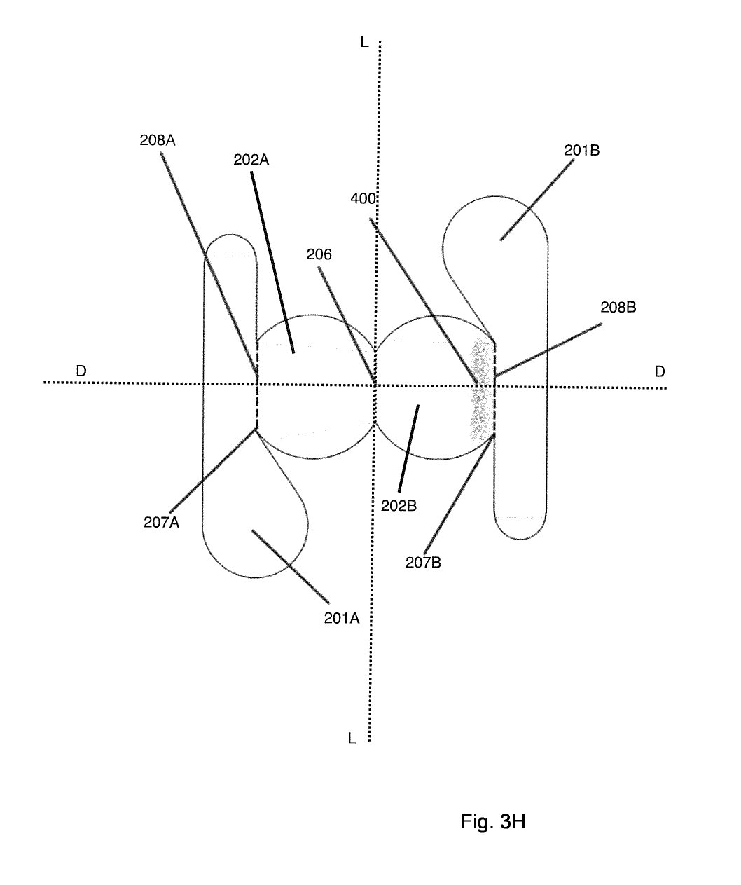

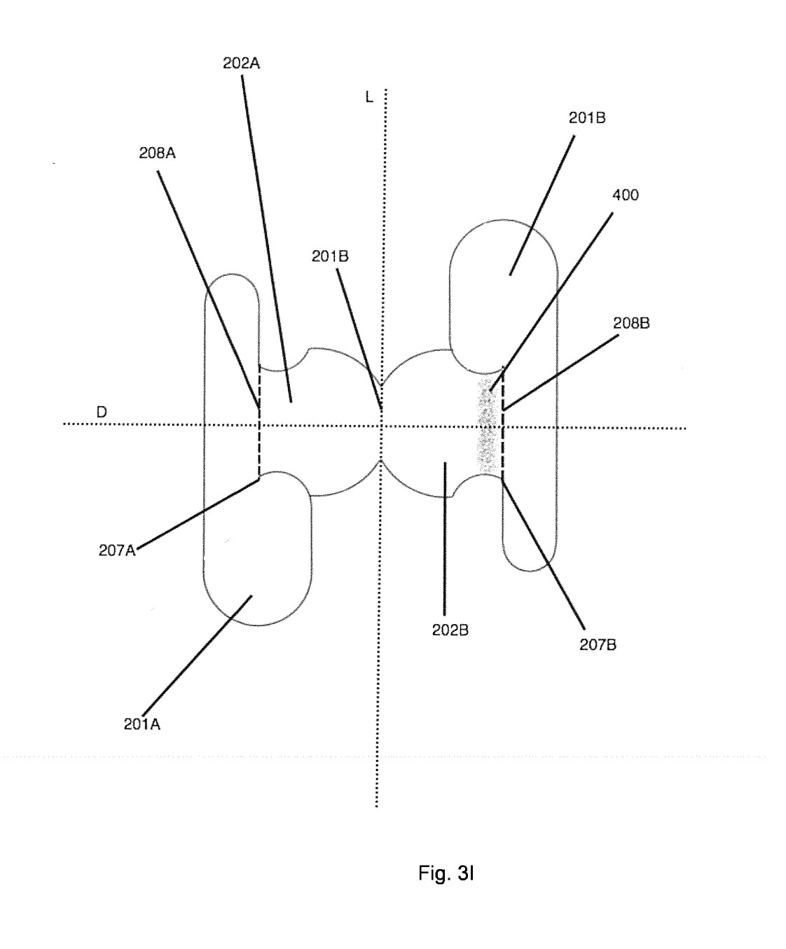

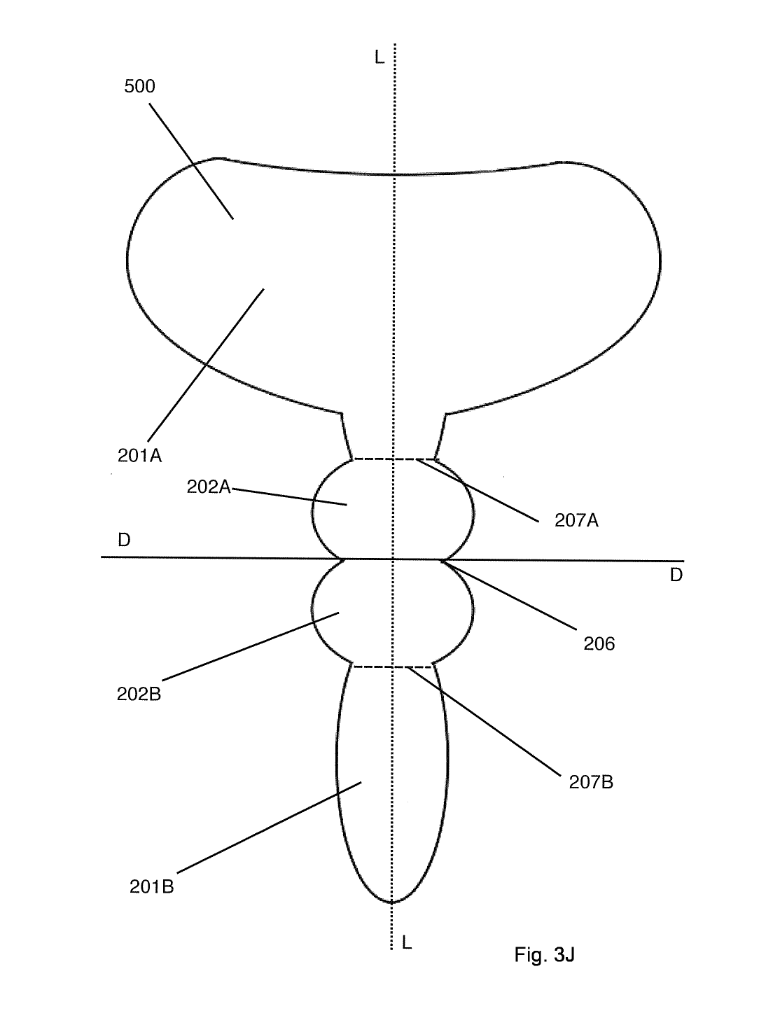

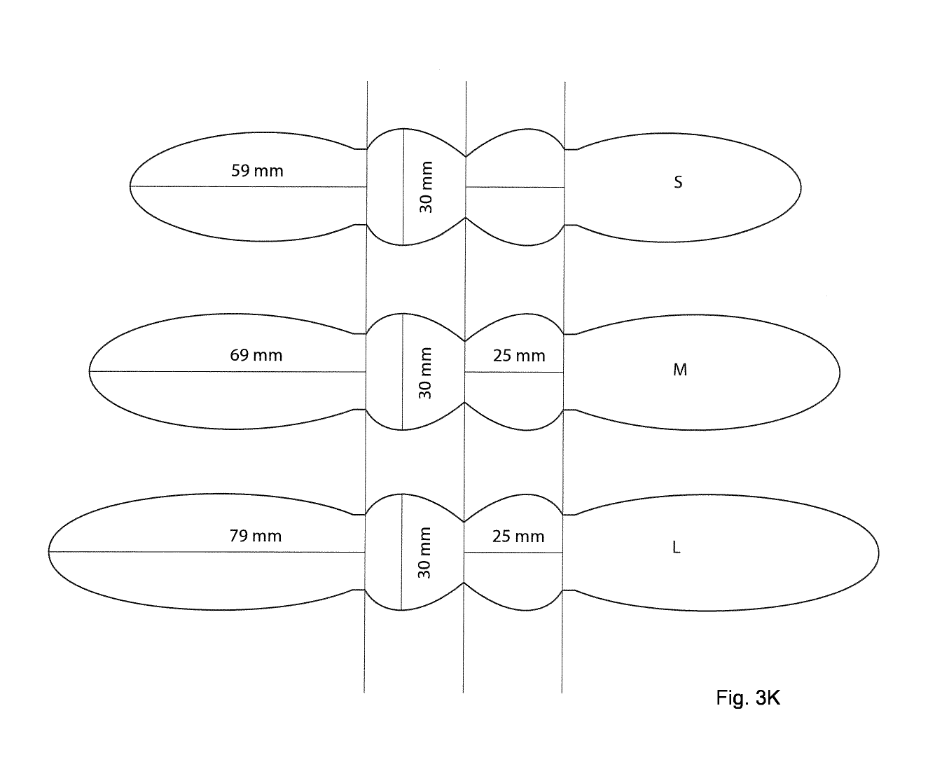

FIG. 3A shows, in a top view, a sticker blank for forming the toilet handle 200. The sticker blank is shown in its initial state. The sticker blank is formed, in particular stamped, from a sticker sheet. The sticker blank is made from a single piece in unitary construction. The sticker blank is longitudinal and has a centrally located longitudinal axis L-L. Furthermore the sticker blank has a centrally located transverse axis D-D. The sticker blank is bilaterally symmetrical over the longitudinal axis L-L. The sticker blank is also bilaterally symmetrical over the centrally located transverse axis D-D. The sticker blank contains a fold line 206. The fold line 206 may be a marked line, for example a printed line or a grooved line, and may be flat or prefolded. The centrally located fold line 206 coincides with the centrally located transverse axis D-D. Furthermore the sticker blank contains at least one transitional fold line 207. The transitional fold line 207 may be made similarly to the embodiment of the fold line 206, for example as a grooved line. The transitional fold lines 207A, 207B extend in the transverse direction and are positioned between the first bonding portion 201A and the first handle portion 202A, or the respective second bonding portion 201B and the second handle portion 202B.

FIG. 3B shows, in a view from the bottom side, a sticker blank as shown in FIG. 3A for forming the toilet handle 200. The bottom side of the sticker blank is provided with at least one adhesive layer. Both bonding portions 201A, 201B contain an adhesive layer 205A, 205B for obtaining adhesion of the toilet handle 200 to a toilet seat assembly 10. The adhesive layer, also known as the bonding layer 205A, 205B, is applied to part of the bottom side of the bonding portion. Part of the bottom side of the bonding portion is preferably free from an adhesive layer. As a result the toilet handle, if desired, can be easily removed again from a toilet seat assembly 10 by a peeling-off motion.

The handle portions 202A, 202B are likewise provided with an adhesive layer 204 for adhesion of the first handle portion 202A to the second handle portion 202B. Before use, the adhesive layers are covered with a cover layer to prevent unwanted premature adhesion.

FIG. 3C, like FIG. 3A, shows a top view of the sticker blank. The embodiment shown of the sticker blank shown is provided with a perforation line. The perforation line is formed by slits that extend over a line. The perforation line forms the transitional fold line 207A. The transitional fold line 207A contains perforations 208A. The transitional fold line 207B contains perforations 208B. The fold line 206 may also be provided with perforations. As a result of the slits, the sticker blank can be folded more smoothly over the fold line. Advantageously the sticker blank can be made thicker due to the presence of slits in the fold lines. The perforations 208B can be formed by slitting or stamping. The perforations 208A between the bonding portion and the handle portion can contribute to a higher degree of hygiene in a sanitary room. The perforations 208A can be made in such a way that the handle portion 202 of the handle tears off from the bonding portion 201 after a number of uses. The size and/or number of the perforations 208A can be designed for a certain number of handle motions and thus an estimated period of use. More or fewer perforations can be applied to provide a shorter or longer period of use respectively. The number of handle motions that the period of use determines, the number of perforations required and the size of the perforations can be determined experimentally. After the period of use has expired, the fact that the handle portion pulls off makes it immediately clear to a user that the handle should be replaced. In this way it is possible to prevent the handle from being used too long in a sanitary room. This improves hygiene.

In an exemplified embodiment (not shown), at least one transitional fold line 207A, 207B can be provided with at least one perforation in a central area of the transitional fold line, wherein an area of the transitional fold line close to the circumferential edge of the sticker blank remains free from perforations. The non-perforated area in particular has a length of at least 2 mm, but preferably a length of at least 3 mm. This is advantageous for removing the handle from an object. In a method for removing the handle from the object, the handle portion 201 can be grasped firmly with a thumb and an index finger. A nail can be positioned on the transitional fold line 207A, after which the handle portion 201 can be pulled away from a first bonding portion 202A that adjoins the transitional fold line 207A. The pulled-off handle portion 201 together with the second bonding portion 202B opposite can be removed from the object using a peeling motion. As a result of the pulling-away of the handle portion 201, the first bonding portion 202A will always be partially loosened from the object. As a result the first bonding portion 202A can also be easily removed from the object by means of a peeling-off motion. Advantageously the sanitary handle with a transitional fold line 207 perforated in the centre area can be removed rapidly and easily from an object.

FIG. 3C also exhibits a cover layer 213 extending beyond the top layer of the sticker blank. The top layer is provided with an adhesive layer on a bottom side. The adhesive layer is applied to at least part of the first and second bonding portions 201A, 201B of the sticker blank. The adhesive layer can be attached to the full surface on the bottom side of the top layer.

A cover layer 213 may comprise two separate cover layer portions, each of which covers a bonding portion 201. The cover layer parts may be provided on one side with a contact layer to shield the adhesive layer. Advantageously, however, a single, double-sided cover layer 213 is provided, which in a folded-together state of the handle protects both bonding portions with the bottom side and top side of the cover layer 213. The size of the double-sided cover layer 213 essentially coincides with the size of a single bonding portion 201. The single double-sided cover layer 213 has a top side and a bottom side which in the folded-together state of the handle lie next to the adhesive layer of the two bonding portions. In the folded-together state of the handle, the double-sided cover layer 213 is located between the two bonding portions 201A, 201B. A lip part of the cover layer 213 may extend outside of the outer contour of the bonding portions 201A, 201B to make it easier to pull the sticker blank open. The top side and the bottom side of the cover layer 213 form a contact layer and are removably adhesively attached to the adhesive layer of the sticker blank. The top side and the bottom side of the cover layer 213 contain, for example, silicones or polyethylene-PE-containing paper. The cover layer 213 is also called backing paper.

FIG. 3D shows an embodiment of the toilet handle 200 in a top view. The toilet handle 200 has a bonding portion 201A with a greater length than the opposite bonding portion 201B. The greater length of the bonding portion 201A gives more space for, for example, an advertising message. The toilet handle 200 with a bonding portion 201A with a greater length is for example more suitable for use on a toilet lid 12, wherein the larger bonding portion 201 may be attached on the upper surface 12B of the toilet lid.

FIG. 3D also shows in the embodiment of the toilet handle 200 that the toilet handle has at least one cut-out. The at least one cut-out 210, 211 is accommodated in at least one bonding portion and/or handle portion. The toilet handle 200 has at least one bonding portion 201A, 201B with a cut-out 211A, 211B. The cut-out 211 is preferably centrally positioned on the bonding portion 201. The cut-out 211 extends outwards over the longitudinal axis L-L of the toilet handle 200. The at least one cut-out 211 is advantageous for applying the bonding portion to a surface with a relief pattern. The toilet handle 200 has a handle portion 202A, 202B with at least one cut-out 210A, 210B.

In particular the cut-out 210 is centrally positioned on the handle portion 202. The at least one cut-out 210 is advantageous for applying an additional item 300, such as a scent, sound or light source. The additional item may also be a decoration, which is suspended from a hanger close to the cut-out. The cut-out 210 may be positioned at any arbitrary point on the handle portion 202; for example, the hanger can be placed closer to the edge so that no obstacles will arise when grasping the handle portion 202. The additional hanger may contain additional items such as decorations, scent cards, holders, etc. The hanger can be easily fastened via a crest, hook or clamp, etc. to the cut-out 210 or the handle portion 202. The hanger may have a luxurious design and for example may be provided with a jewel. After the addition of an item, the cut-out 210 in the handle portion 202 may be covered with a cover plate 301. The cover plate 301 may for example be provided with a print, such as a logo. The cut-out 210 in the handle portion of the toilet handle 200 can form a continuous gap for hanging an additional item, wherein the additional item can be fastened to the continuous gap. The additional item 300 may have a chain with a hook for easy fastening to the handle portion of the toilet handle 200.

FIG. 3G shows a separate additional item 300 that can be provided in a toilet handle 200. The item 300 can be accommodated in the cut-outs 210 of the toilet handle 200 or may be positioned between the handle portions 202A, 202B. The item may be flat. The item may be folded between the handle portions 202A, 202B. The item is equipped for inducing a sensory perception from the user. The item 300 is equipped to emit a signal, for example a sound, scent, light or warning signal. The item contains for example a source of sound, scent or light, an indicator and/or sensor for indicating a parameter, such as temperature, time, humidity, UV, stress, etc. The item may contain a microchip. The microchip may be set up to play a sound when the toilet handle is moved. The microchip may be designed for lighting up the toilet handle. The microchip may emit a first colour, for example green, to show that the toilet handle is functioning as desired and a second colour, such as red, to indicate that the toilet handle needs to be replaced. The item as a scent item may for example contain a scent reservoir, such as a liquid-absorbing pad. When the toilet handle 200 is used, the scent item can release a scent. Advantageously the user will consequently experience a public sanitary environment as fresh.

FIG. 3E shows, in a top view, an alternative embodiment of a sticker blank. This embodiment is specifically suitable for use on a cabinet door. FIG. 3E shows an outline of the sticker blank for forming a handle, while FIG. 3F shows the same sticker blank in a folded-together state. The outline of the sticker blank is rotationally symmetric. The sticker blank has two centrally located handle portions 202A, 202B. The outline of the sticker blank is longitudinal. At the ends, the sticker blank has bonding portions 201A, 201B. The bonding portions 201A, 201B are adjacent to the handle portions 202A, 202B. As shown in FIG. 3F, the handle portions can be folded towards each other and together over a fold line 206. The fold line 206 forms a transverse axis D-D. When the handle portions are folded together, the bonding portions 201A, 201B move together. The bonding portions 201A, 201B in the folded-together state partially overlap. A transitional fold line 207A, 207B forms a separation between the bonding portions 201A, 201B and the handle portions 202A, 202B of the handle. The transitional fold line 207A, 207B changes to a break line 209A, 209B. The break line 209 extends outwards from the transitional fold line to an outer circumference of a bonding portion. The break line 209 is provided to be broken by a user to form the handle. Here the break line 209 is torn. In a top view the handle in a folded-together state has a circular outer contour of attractive appearance.

FIG. 3H shows a top view of an outline of an alternative embodiment of a sticker blank for forming a handle. The sticker blank is rotationally symmetrical in the outline. In contrast to the sticker blank of FIGS. 3E, 3F the sticker blank is formed without a break line 209. The handle can be formed by folding the sticker blank over the fold line 206 and the transitional fold lines 207A, 207B. The transitional fold lines 207A, 207B are provided with perforations 208A, 208B as slits to facilitate folding. After folding together, the bonding portions 201A, 201B partially overlap. The overlapping part of the bonding portions 201A, 201B advantageously provides for a graspable pull-off lip for removing the handle. The handle portions 202A, 202B are bonded together with an extra adhesive 400. The adhesive 400 is in addition to or replaces the adhesive layer of the handle portions. The adhesive 400 advantageously provides extra stiffness and thickness to the handle portion in the folded-together state. The adhesive 400 has an longitudinal shape here. The longitudinal-shaped adhesive 400 extends outwards in the transverse direction. Here the adhesive 400 is applied to one of the handle portions 202B adjacent to the transitional fold line 207B. The adhesive 400 can also be provided adjacent to the fold line 206 such that a thickening in the handle portion is formed by folding together and a better grasp can be achieved.

FIG. 3I shows in a top view an outline of a variant of the embodiment according to FIG. 3H. The sticker blank is rotationally symmetric. The sticker blank is made with a break line 209A, 209B. The sticker blanks as shown in FIG. 3H and 3I are particularly suitable for use on the handles of cabinets.

FIG. 3J shows in a top view an outline of a sticker blank for forming a handle. The handle is in particular suitable as a handle for children. The handle has an enlarged second bonding portion 201B with respect to a first bonding portion 201A. The bonding portion 201A has a contact surface 500. The contact surface 500 has a surface area of at least 100 cm². The enlarged bonding portion forms a contact surface 500 for a hygienic contact with respect to an object. The enlarged bonding portion may be provided with an antibacterial material. The contact surface 500 may for example be attached to a top side of a toilet seat to form a support surface, on which hands can be placed. In particular for small children it is advantageous for them to be able to place their hands on a hygienic contact surface 500 of the handle. The handle portions 202A, 202B, have a surface area of at least 5 cm², in particular at least 10 cm², so that the handle portion in the folded-together state of the handle can be grasped more easily and firmly. This may be advantageous for users, such as the elderly and children, who have less strength in their fingers.

FIG. 3K shows in a top view three different sizes of sticker blanks. One packet of sticker blanks may contain at least two sizes, preferably three sizes. Preferably the packet with three sizes is a sanitary packet. In the case of the different sizes, in each case the handle portions are of essentially the same size while the bonding portions differ in length for each size. The handle portions have a width of approximately 30 mm and a length of approximately 25 mm. The smallest sized sticker blank, size S, has a bonding portion with a length of approximately 59 mm. Size M has a bonding portion with a length of approximately 69 mm. Size L has a bonding portion with a length of approximately 79 mm. Advantageously, the largest size, size L, is suitable for application to a toilet lid, but as a result of its great length it is unsuitable for use on a toilet seat. The sizes M and S are suitable for use on a toilet seat. Size M is suitable for larger toilet seats, while size S is primarily suitable for the smallest toilet seats. A size of at least 40 mm, in particular at least 50 mm, provides adequate adhesion to a toilet seat.

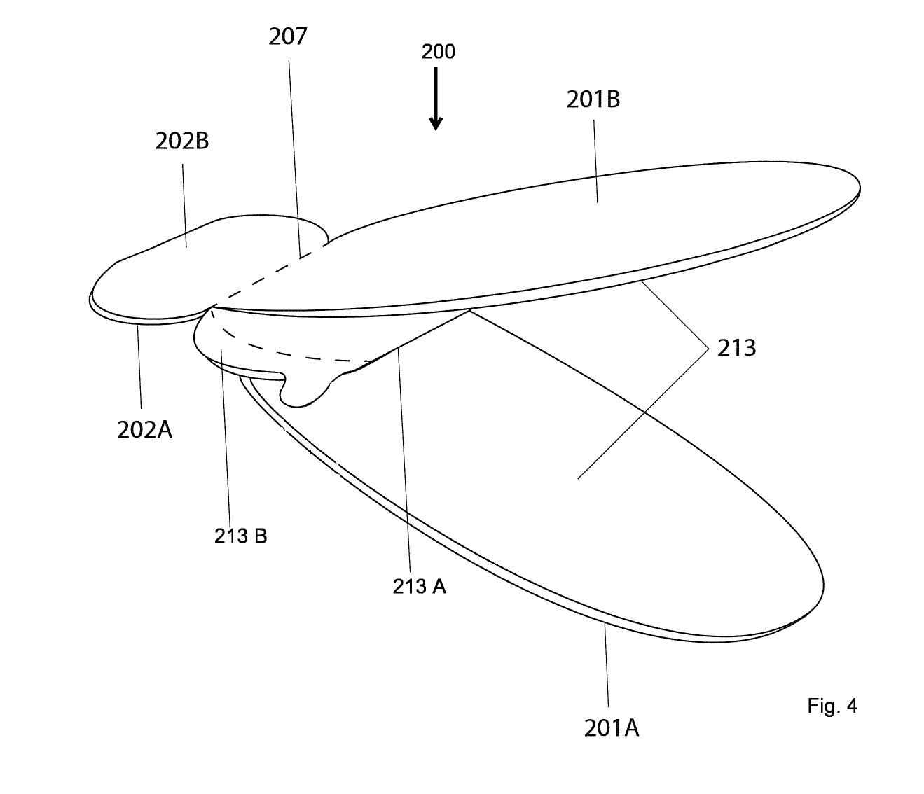

FIG. 4 shows in a perspective view an embodiment of a handle 200 from the sticker blank according to the invention in an intermediate state before use, wherein the handle portions of the handle are already bonded together. The handle 200 has a handle portion 202 and bonding portions 201. The handle portion 202 is formed from two handle portions 202A, 202B adhered to one another. The handle 200 has a cover layer 213. The cover layer 213 covers the bonding portions 201. In a centrally located area of the sticker blank, the cover layer 213 has a part that is free. The free part of the cover layer 213 can be obtained by partially pulling away the cover layer 213 from the handle portions 202A, 202B. The cover layer 213 for covering a bottom side of the top layer 212 may comprise two separate cover layer parts to be removed separately from the top layer 212. However, here the cover layer 213 is made in one piece. The cover layer 213 is a single item. The entire cover layer 213 can be removed by a user from the top layer 212 with a single motion. The free part of the cover layer located in the intermediate state of the handle between the bonding portions is obtained by folding together a centre area of the cover layer 213. In the centre area the cover layer 213 is folded together over a fold line 213A. The free part of the cover layer 213 contains a lip part 213B, also known as a pull-off lip, for pulling off the cover layer 213. The lip part 213B is a part of the cover layer 213 that extends out beyond the contour of the bonding portions 201. The lip part 213B is provided to make removal of the cover layer 213 from the top layer 212 easier. Furthermore it is advantageous to allow the cover layer 213, in particular the lip part 213B, to serve as an information carrier. Here the lip part 213B contains a protrusion that makes it easier to grasp the cover layer 213 with the fingertips. The protrusion can be drop-shaped. The lip part 213B can be simply stamped out of the cover layer 213. However, the lip part advantageously contains a reinforced lip part relative to the remaining part of the cover layer. Preferably the lip part 213B is stamped out of the combination of the top layer 212 with the cover layer 213. As a result the lip part 213B can comprise a reinforced part and can provide improved grasp when removing the cover layer 213 from the top layer 212. A dotted line on the free part of the cover layer 213 indicates that the lip part 213B can be removable from the cover layer 213. The dotted line can, for example, be a score line.

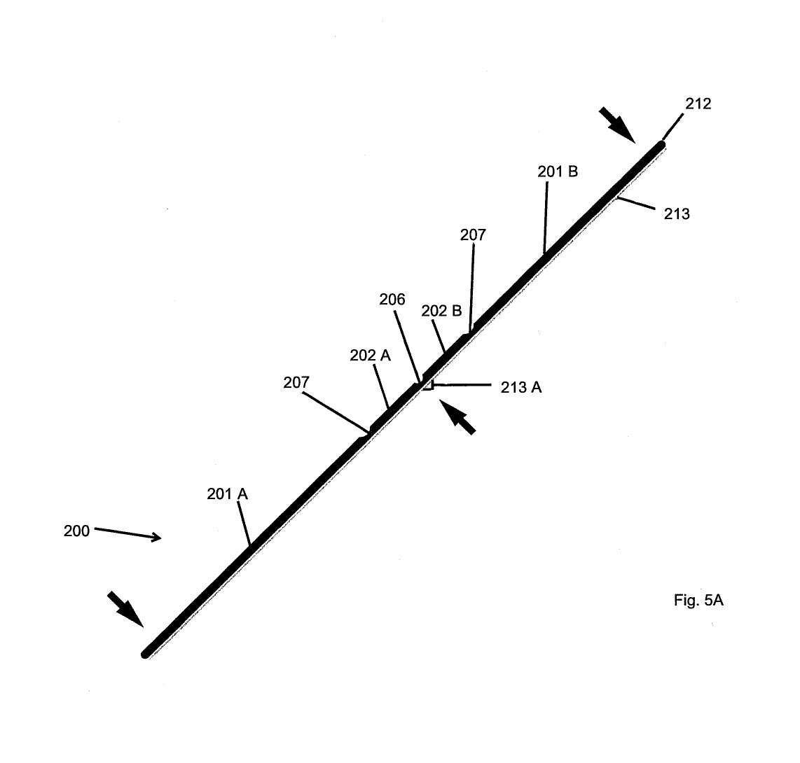

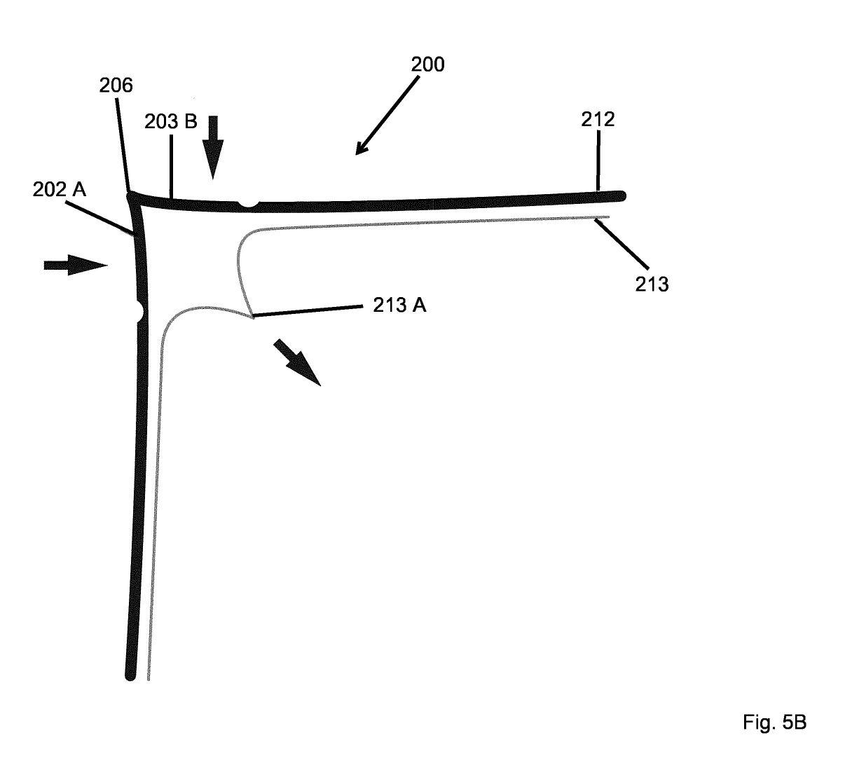

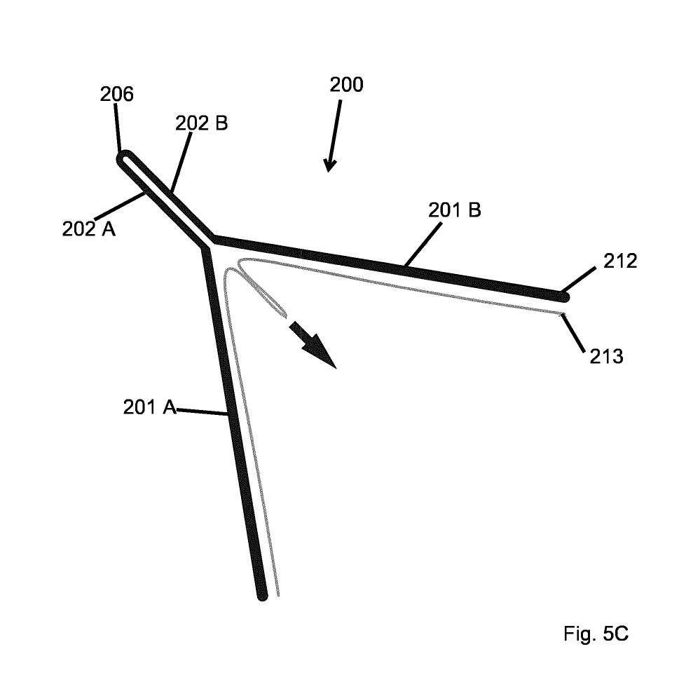

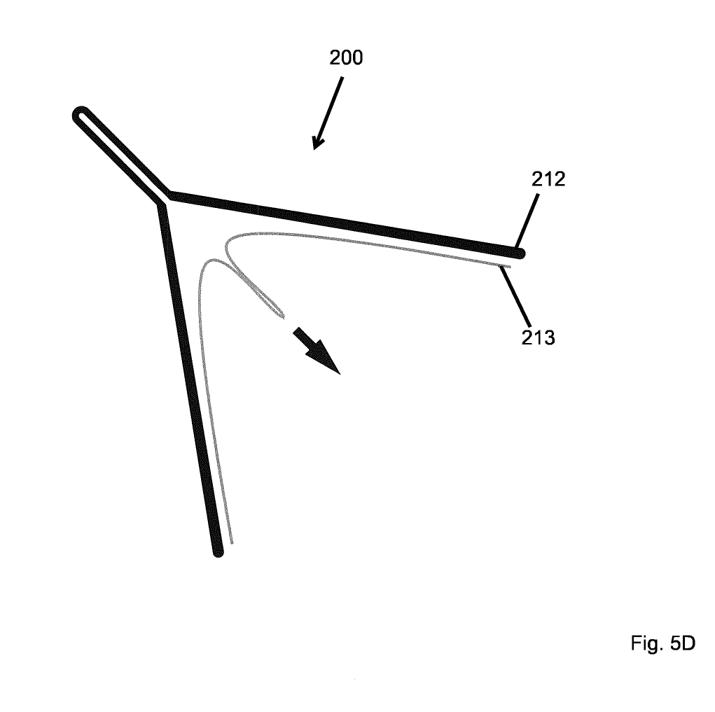

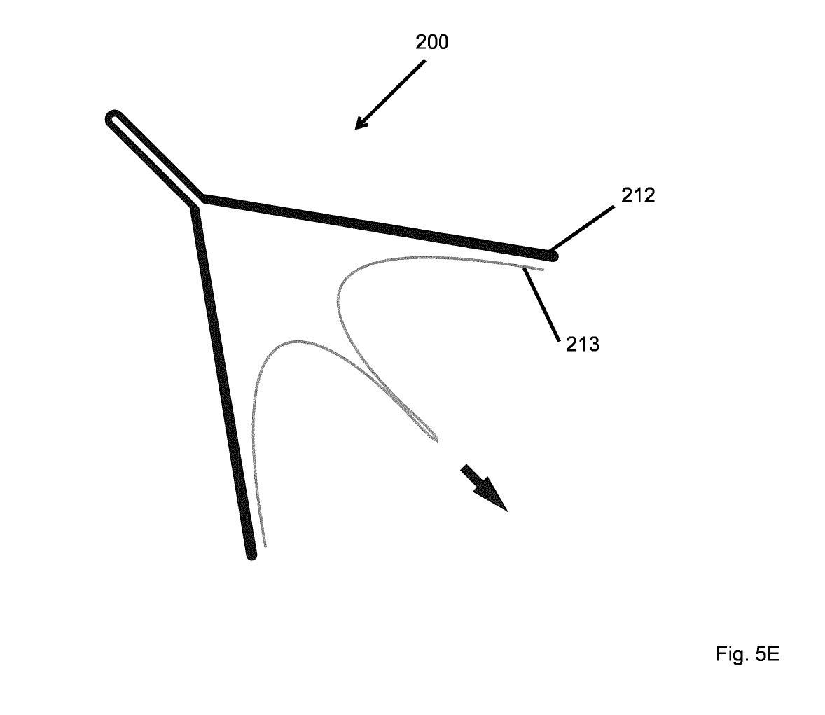

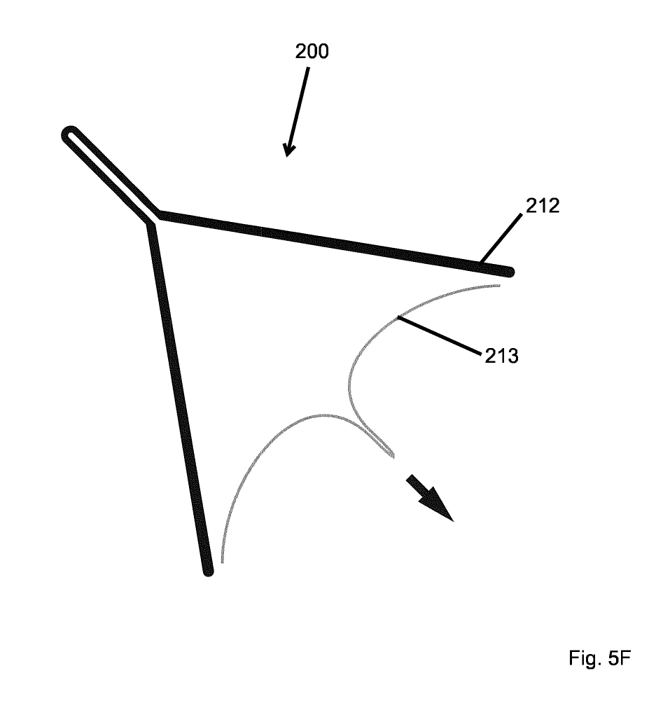

FIGS. 5A-5F show successive folding motions for obtaining a handle from a sticker blank. The intermediate state of the folded handle, as shown in FIG. 4, corresponds to FIG. 5C.

In a schematic view in longitudinal cross-section, FIG. 5 shows a sticker blank according to the invention that can be formed by folding the sticker blank into a handle 200. The sticker blank has a top layer 212 that is provided on a bottom side with a cover layer 213. The cover layer 213 in a centrally located area has a fold pleat 213A. The pleat 213A can be grasped with the fingertips by a user to pull the cover layer 213 away from the top layer 212. The sticker blank has a first bonding portion 201A and a second bonding portion 201B. Furthermore the sticker blank has two handle portions 202A, 202B located between the bonding portions. The two handle portions 202A, 202B are separated from one another by a fold line 206. The handle portions are separated from the bonding portions by a transitional fold line 207.

In each of FIGS. 5A-5F, arrows are presented which indicate a direction of a folding motion. In FIG. 5A arrows are presented at the ends of the sticker blank which indicate that the bonding portions 201 are to be folded towards one another in a next step. The arrow shown in the centre area indicates that the handle portions 202 are also to be folded towards one another.

FIG. 5B shows the result of the folding motion, as indicated with arrows in FIG. 5A. The handle portions and the bonding portions have been moved towards one another. The cover layer 213 in the central area of the sticker blank has been pulled away from the top layer 212. In the centre area of the sticker blank, the cover layer 213 is free from the top layer 212. The pleat 213A forms a fold line in the cover layer 213. The arrows shown in FIG. 5B indicate the next step in the folding motion. The handle portions 202A, 202B located on the inside have been moved closer together. In addition, the cover layer 213 has been pulled farther away from the top layer 212. FIG. 5C shows the result of the folding motion as indicated in FIG. 5B.

In FIG. 5C the handle portions 202A, 202B are adjacent. The cover layer 213 is still connected to the bonding portions 201A, 201B. In this way an intermediate state of the handle 200 is attained. The handle 200 can be delivered in this intermediate state, to a user, so that the user can simply apply the handle 200 to an object.

In FIGS. 5D-5F, the next steps of the folding motion are shown. In particular, by pulling on a free part 213B of the cover layer 213, the cover layer 213 is farther and farther removed from the top layer 212. The cover layer in this way can be removed from the top layer 212 via a pulling motion. After removal of the cover layer 213, the handle can be attached to an object.

In addition to the embodiment of the sticker blank shown in FIG. 5, wherein the cover layer 213 is made from one piece, it is also possible to form the cover layer 213 from two separate cover layer parts. The cover layer parts can cover the first and the second bonding portions respectively and be removed in succession, one after the other. A cover layer 213 made of two cover layer portions is advantageous, since during its use it is possible to prevent the bonding portions from sticking together prematurely. A first bonding portion 201A can be bonded to an object in a first step, and only after that is a cover layer part removed from a second bonding portion 201B, so that the second bonding portion 201B can also be bonded to the object. In this way the bonding portions can be prevented from sticking to one another.

On the other hand it is possible in an alternative embodiment to omit a separate cover layer and allow the two bonding portions to also serve as cover layers for one another by double-folding the sticker blank.

In addition to the embodiments shown in the figures, many variants are possible. The handle that is formed from the sticker blank is shown in the embodiment of a toilet handle. In addition to the toilet lid and the toilet seat, the handle can also be applied to a button on the toilet water reservoir to operate the toilet. The handle made from the sticker blank can also be used in other applications for operating a moveable object, for example for operating a cabinet door, top, switch, pushbutton, etc. Specifically, the handle that can be formed from the sticker blank and contains an antibacterial material is suitable for use in a sanitary environment in which hygiene is in particular important. For example, the handle is suitable for use in a hospital environment, a dental practice, a catered event, children's day care, schools, etc. For the sake of simple, cost-advantageous production possibilities, the handle made from the sticker blank is suitable, as a disposable product, for such uses. The indicated fold lines or transitional fold lines can be made as score lines, stamped, a cut line, etc.

Specific characteristics illustrated in the exemplified embodiment of the toilet handle may also be used for a handle for other applications and therefore can be generally incorporated in the claims as distinguishing features. Specifically, shape-related aspects, such as the positioning of the fold lines, a smooth outer contour, the tapering between a bonding portion and a handle portion, and a thumb size of a grasping portion of a handle portion are aspects that provide differentiating advantages for providing a handle from a sticker blank in a handle with more general use.

Although the invention is disclosed with reference to particular embodiments, a person skilled in the art, after reading the description, may wish to make changes or adaptations that are possible from a technical viewpoint, but definitely do not fall outside the scope of protection of the invention as defined in the attached claims. Changes relative to the disclosed embodiments can be made which fall within the teaching of the invention without thereby departing from the essence of the invention. The person skilled in the art must understand that elements can be omitted, various adaptations may be made, and that elements can be replaced by equivalent ones without thereby leaving the essence of the invention. Thus the invention is not limited to the disclosed embodiments that are included in the description, but the invention covers all embodiments that fall within the scope of protection as defined by the claims.

1.-32. (canceled)

33. A sticker blank for forming a handle, in particular a toilet handle, wherein the sticker blank has a top layer with a bottom side provided with an adhesive layer, wherein the adhesive layer has a removable cover layer for initially covering the adhesive layer, wherein the sticker blank has two bonding portions for attaching the handle to a moveable object, in particular a toilet seat assembly, which bonding portions are positioned at two ends of the sticker blank, and at least one handle portion for providing a hand grip, and wherein the at least one handle portion is positioned in a centrally located area of the sticker blank.

34. The sticker blank according to claim 33, wherein the sticker blank is elongated.

35. The sticker blank according to claim 33, wherein the sticker blank has two handle portions that are positioned in a centrally located area of the sticker blank, wherein the two handle portions are connected to one another by a fold line.

36. The sticker blank according to claim 35, wherein the sticker blank is elongated and comprises at least one of the following features:
the sticker blank has a longitudinal axis L-L in the lengthwise direction, wherein the fold line extends in a transverse direction D-D relative to the longitudinal axis L-L;
the sticker blank is made to be bilaterally symmetrical around the longitudinal axis L-L;
the sticker blank is made to be bilaterally symmetrical around a centrally located transverse axis D-D;
the sticker blank in an intermediate position of the handle is doubled over the fold line, wherein a first bonding portion is immediately adjacent to a second bonding portion without an intermediate, separate cover layer, such that the first bonding portion forms a cover layer for the second bonding portion and the second bonding portion forms a cover layer for the first bonding portion respectively.

37. The sticker blank according to claim 35, wherein the sticker blank has a transitional fold line which is positioned between a bonding portion and a handle portion, wherein the folding line comprises at least one of the following features:
the transitional fold line has at least one slit;
the at least one slit is positioned in a central area of the transitional fold line;
the sticker blank also has a tapered portion that forms a transition from the bonding portion to the handle portion.

38. The sticker blank according to claim 35, wherein the handle portion has a maximum size of 10 cm², and particularly at least 2 cm², such that the handle portion forms a grasping portion for grasping with a thumb and a forefinger.

39. The sticker blank according to claim 35, wherein the bonding portion has a cut-out such that the bonding portion can be bonded on an irregular substrate.

40. The sticker blank according to claim 35, comprising at least one of the following features:
the sticker blank has an additional item such as a sensor, indicator, or a source of sound, scent, or light;
the sticker blank is rotationally symmetric;
the sticker blank has a top layer made of a plastic film and in particular contains an antibacterial material;
the top layer contains a photoluminescent material;
a marginal portion of the bottom side of the top layer is free from an adhesive layer, so that a pull-off lip is formed for pulling the handle off of an object after adhesion of the handle;
the pull-off lip has a rough surface to provide a grip.

41. The sticker blank according to claim 35, wherein the sticker blank has one, double-sided cover layer with a bottom side and a top side which are formed as a contact layer to lie adjacent to the adhesive layer, wherein the one cover layer in a folded-together state of the handle is located between the two bonding portions and protects the adhesive layers of the respective bonding portions with the bottom side and top side of the cover layer, wherein particularly a lip portion of the cover layer extends beyond the outer contour of the bonding portions for pulling the sticker blank open.

42. A sticker blank to form a toilet handle, wherein the sticker blank has a top layer with a bottom side provided with an adhesive layer, wherein the adhesive layer has a removable cover layer to initially cover the adhesive layer, wherein the sticker blank is elongated and has a longitudinal axis L-L in a lengthwise direction, wherein the sticker blank has two bonding portions to attach the handle to a moveable a toilet seat assembly, which bonding portions are positioned at two ends of the sticker blank, and two handle portions to provide a hand grip, which two handle portions are positioned in a central region of the sticker blank and are connected to one another by a fold line which fold line extends in a transverse direction D-D relative to the longitudinal axis L-L and wherein the sticker blank has a transitional fold line which is positioned between a bonding portion and a handle portion.

43. A handle formable from a sticker blank according to claim 35, in particular having user instructions with instructions for folding the sticker blank into a handle, wherein particularly the handle is formed by folding the sticker blank over a fold line, wherein particularly the handle portions of the handle in an initial state before use are present in a folded-together state, adjacent to one another, and wherein the bonding portions of the handle are located opposite one another and are separated from one another by one double-sided cover layer located between them, wherein the cover layer is provided, on opposite sides, with a contact layer that adheres removably to the adhesive layer of the bonding portions.

44. A sticker roll containing a multiplicity of sticker blanks for forming, specifically folding, a handle, wherein each sticker blank has a top layer with a bottom side which is provided with an adhesive layer, wherein the sticker roll has a removable cover layer for the initial covering of the adhesive layer of a sticker blank, wherein each sticker blank has at least one bonding portion for bonding the handle to a moveable object, in particular a toilet seat assembly, and at least one handle part for creating a hand grip.

45. A cleaning packet containing a sticker blank, particularly at least two different sticker blanks, according to claim 35, also particularly containing a cleaning agent, such as a degreasing agent, a cleaning cloth or a cleaning sponge, wherein the cleaning packet is particularly a toilet cleaning packet containing a package with at least one toilet handle according to one of the preceding claims and in particular at least one toilet cleaner.

46. A method for providing a handle, in particular a toilet handle, on an object, in particular a toilet seat assembly, wherein the handle is formed with a sticker blank, comprising the steps of:
forming the handle from the sticker blank, wherein the handle has a bonding portion and a handle portion;
removing a cover layer from the bonding portion of the handle; and
bonding the bonding portion to the object.

47. The method according to claim 46, comprising at least one of the following features:
the sticker blank has a fold line, wherein the method also includes the step of folding the sticker blank over the fold line;
the handle has a first and a second bonding portion, wherein the first bonding portion is bonded to an upper surface of the object and the second bonding portion is bonded to a lower surface of the object;
the handle has a first and a second bonding portion, wherein the first bonding portion and the second bonding portion are bonded alongside one another on a surface of an object;
the handle made from a sticker blank is in an intermediate state, wherein a cover layer is provided for covering bonding portions, wherein the cover layer has an unattached part that forms a grip for removing the cover layer, wherein the unattached part is positioned between the bonding portions and adjacent to a handle portion.

48. Use of the sticker blank according to claim 35 for forming a hygienic handle in a sanitary environment.
